(19) United States
(12) Patent Application Publication
(10) Pub. No.: US 2008/0244375 A1
(43) Pub. Date: Oct. 2, 2008

(54) Hyperlinking Text in Document Content Using Multiple Concept-Based Indexes Created Over a Structured Taxonomy

(75) Inventors: Tony Gentile, San Francisco, CA (US); Rakesh Sharma, San Mateo, CA (US); Jason Pump, Oakland, CA (US); Niraj Katwala, Hayward, CA (US); Sujit Pal, Antioch, CA (US); Timothy England, Pacifica, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: HEALTHLINE NETWORKS, INC., San Francisco, CA (US)

(21) Appl. No.: 12/029,364

(22) Filed: Feb. 11, 2008

Related U.S. Application Data
(60) Provisional application No. 60/889,135, filed on Feb. 9, 2007.

(51) Int. Cl. G06F 17/00

(52) U.S. Cl. 715/205

(57) ABSTRACT

Hyperlinks are automatically created and inserted into a subject document at the location of a subject concept within the subject document. The determination of when and where to insert the hyperlinks is made on the basis of associations of the subject concept with one or more object resources (to which the hyperlinks will point) according to semantic relationships between the subject concepts and the object resources as defined by a taxonomy. The hyperlinks may be displayed within a published version of the subject document in response to a cursor-control event.

### RELATED APPLICATION

This application is a NONPROVISIONAL of, incorporates by reference and hereby claims the priority benefit of U.S. Provisional Patent Application No. 60/889,135, filed 9 Feb. 2006.

### FIELD OF THE INVENTION

The present invention relates to systems and methods for automatically identifying subject concepts within documents and, subject to user-defined rules, associating such concepts with hyperlinks to one or more resources according to semantic relationships between the subject concepts and the resources as defined by a taxonomy.

### BACKGROUND

The myriad of communicatively coupled computer systems and networks that make up the Internet has made a vast amount of information available to virtually anyone with access to a personal computer, mobile phone or personal digital assistant. Of course, the benefits of such availability are tempered by limitations on an individual's ability to locate information relevant to his or her needs. That is, because individual documents must be stored at particular locations, unless the user can uncover the location at which a particular document of interest is stored, the user will be unable to avail him- or herself of the information included in that document. In the case of the Internet, the number of possible storage locations is so large (and ever changing) that no individual can possibly hope to remember where every document of interest is stored.

In order to address this problem, techniques have been developed to allow a user to locate a document of interest based on information other than the address of a computer system where a subject document is stored. For example, search engines can assist a user in locating a document based on attributes of the document or even its content. Of course, this technique only works if the user can formulate a search query in the language of the document's content or attributes. Another method of locating a document of interest is based on navigating relationships between the subject document and other materials, the locations of which are known. The navigable relationships are typically specified by hyperlinks; electronic links between documents.

While navigating hyperlinks from known locations can provide beneficial results, in some cases even more so than is provided by search techniques (e.g., because the user typically can comprehend the context of the relationship which is suggested by the hyperlink but may be unable to formulate a search query that yields sufficiently relevant results), where the volume of information that needs to be interrelated through the use of hyperlinks is large, the cost of doing so may be prohibitive. Moreover, even where the cost is not so great as to prohibit the interrelating of a large collection of information in this fashion, consistency in fashioning such links can be difficult to maintain. For example, if humans are relied upon to create the relationships between various documents, then individual biases of those individuals may affect how each one views the relevance of one document to another.

In order to avoid these inconsistencies, various schemes for the automatic determination of relevance between two or more documents and the subsequent creation and insertion of hyperlinks within those documents (thereby to relate the subject documents to one another) have been proposed. Many such techniques rely on the computation of similarly vectors between different ones of the documents of interest in order to determine where to place the links. A failing of this approach is that it are rooted in the notion that documents that are (or should be) related in some fashion will necessarily share common words. This fails to account for linguistic factors such as synonymy and polysemy and other factors such as subtle errors in translations and the like.

### SUMMARY OF THE INVENTION

In one embodiment, the present provides for automatically identifying a subject concept within a subject document; and, subject to user-defined rules, associating the subject concept with one or more object resources according to semantic relationships between the subject concepts and the object resources as defined by a taxonomy; and inserting one or more hyperlinks to the associated object resources into the subject document. The hyperlinks may be displayed within a published version of the subject document in response to a cursor-control event.

### BRIEF DESCRIPTION OF THE DRAWINGS

The present invention is illustrated by way of example, and not limitation, in the figures of the accompanying drawings in which:

FIG. 1 illustrates an example of a system for automatically identifying subject concepts within documents and, subject to user-defined rules, associating such concepts with hyperlinks to one or more resources according to semantic relationships between the subject concepts and the resources as defined by a taxonomy, in accordance with an embodiment of the present invention;

FIG. 2 illustrates an example of a process for processing a batch of subject documents in accordance with an embodiment of the present invention;

FIG. 3 is a screen shot illustrating an example of the presentation of hyperlinks in a subject document to object resources, in accordance with an embodiment of the present invention; and

FIG. 4 is a further example of a navigation interface to object resources, in accordance with an embodiment of the present invention.

### DETAILED DESCRIPTION

Described herein are methodologies for the automatic determination of relevance between two or more documents and the subsequent creation and insertion of hyperlinks within those documents. To facilitate this process, the present invention makes use of a data structure associated with the information space for the documents of interest to help determine semantic closeness of pieces of information. In one embodiment of the invention, the data structure is fashioned as a taxonomy of medial/health terminology. The use of this taxonomy allows various topics within the health field to be related to one another, thereby permitting the creation and embedding of highly relevant hyperlinks to associate terms in new documents of interest to other documents within a library.

The present invention may be implemented in a variety of fashions. In one example, the invention is instantiated as a web authoring/publishing tool that automatically identifies medical concepts in the text of a subject document, and automatically inserts hyperlinks in that text, enabling readers to navigate (e.g., by invoking a cursor control event such as a mouse click or other selection event) from the identified medical concepts to other relevant resources (e.g., encyclopedia articles, definitions, authoritative articles, etc.). Although the invention will be discussed in the context of such an implementation, it should be remembered that this is merely an example and the invention should not be limited thereby.

The following terms will be used in connection with the description of the web-based tool:
a. Subject Concept—Each individual concept which is identified in a subject document that will be processed to include hyperlinks in accordance with the present invention.
b. Subject Document—Each individual document in which the hyperlinks will be embedded. For example, this could be a list of news articles which are produced by a news publisher on a periodic basis (e.g., daily, weekly, monthly, quarterly, yearly).
c. Object Resource—A resource (typically a digital document, where the terms document may encompass documents (in any format), spreadsheets, presentations, web pages, images, movies, audio files, etc.) to which a hyperlink from a subject concept in a subject document refers. In some instances, object resources may be encyclopedia articles or collections of documents (e.g., a collection of disease-specific documents that provide rich details on individual diseases, or a collection of drug-specific articles licensed by the operator of a web portal through which the subject documents (and, optionally, the object resources) are made available to users). In addition, an object resources may be styled as quiz, for example to be taken after reviewing an article or other content. In still other examples, an object resource may be an advertisement, or other content provided by an advertiser or sponsor of a web portal, etc. Examples of well-known object resources include A.D.A.M.™ (a library of health-related publications available through Adam, Inc.), authoritative articles available via Healthline™ (a web portal operated by the assignee of the present invention), dictionary definitions published by authoritative reference sources, etc.
d. Object Index—An index which is built on a collection of object resources to facilitate quick lookup (e.g., an index built on a collection of disease-specific documents providing information on individual diseases). Each object index has one or more semantic types associated with it and a back-end system (discussed below) is responsible for preparing an object index for each set of similar object resources. The resulting list is broadcast from the back-end system to a front-end system, as discussed further below.
e. Subject Semantic Type—Semantic type of the subject concept to be hyperlinked. For example, cancer has a semantic type of neoplastic process, diabetes has a semantic type of disease, pregnancy has a semantic type of condition, etc.

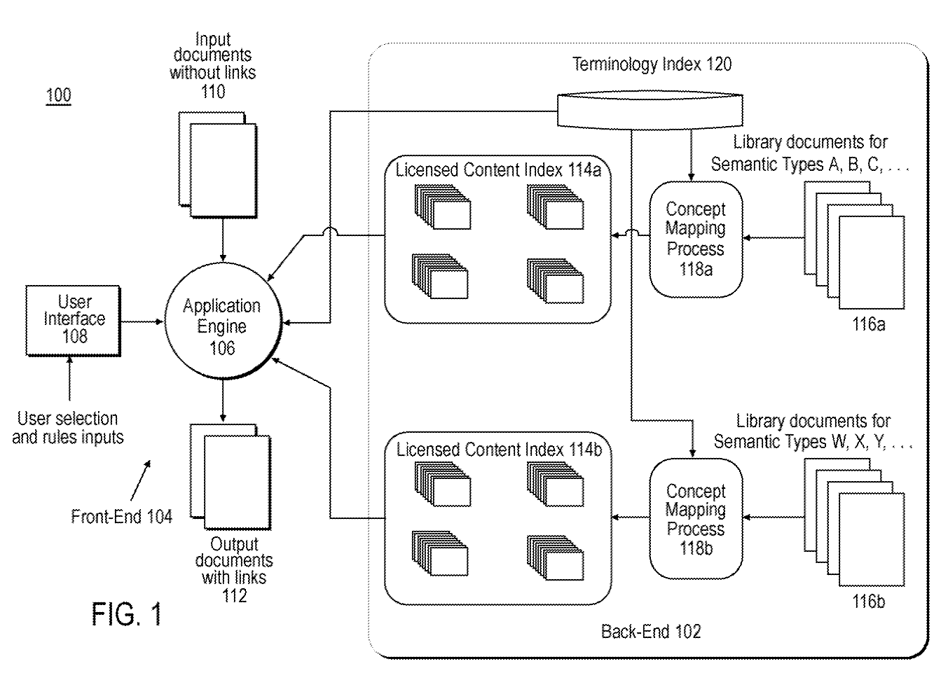

Referring now to FIG. 1, the architecture of a system 100 configured to automatically determine relevance between two or more documents and subsequently create and insert hyperlinks within those documents in accordance with the present invention is illustrated. System 100 includes a back-end system 102 and a front-end system 104. The front-end includes an application engine 106 and a user interface 108. Stated simply, the user interface provides means by which an administrator or other user can configure the application engine for its tasks of automatically creating and inserting hyperlinks to libraries of content into input documents 110, which do not include such links, to create output documents 112, which do include such links. Generally, the input documents (or subject documents) may be of any type, for example, HTML documents, XML documents, text-based documents (e.g., produced by any word processor), etc. In one embodiment of the invention the output documents are all HTML documents. Hence, the application engine 106 may be configured to produce HTML output documents from non-HTML input documents.

Among the configuration settings for the application engine are:
a. The semantic type subject concepts within a subject document that are to be configured as hyperlinks.
b. For each semantic type, the object resource indexes (shown in the illustration as licensed content indexes 114a and 114b) that should be accessed.
c. The number of instances of the same subject concept within a subject document that should be configured with a hyperlink.
   These settings, which may be cast as business rules for the application engine, may be specified through the user interface 108, which in some instances may be a graphical user interface while in other instances may be a command line interface.

The application engine is configured to interpret the business rules that specify how and where to create the hyperlinks to documents or other items in the licensed content indexes and insert those hyperlinks into the subject documents 110. This may be done on a subject document-by-subject document basis or as a batch process across a set of subject documents. In either case, the output of the application engine is a set of hyperlinked HTML documents 112.

The various licensed content indexes 114a, 114b, may be libraries of any size and may include a variety of documents 116a, 116b of different semantic types. These documents form the collection(s) of object resources to which the hyperlinks that will be embedded in the subject documents will point. The libraries are segregated by semantic type because it facilitates easier ranking of the documents in terms of relevance or otherwise. In other embodiments, a single, non-segregated library of object documents may be used.

The object documents are each processed by a concept mapping process. Where the documents are segregated by semantic type attributes, respective concept mapping processes 118a, 118b, may be used (as shown). The outputs of the concept mapping processes are the respective sets of object indexes known as the licensed content libraries 114a, 114b. Each of these indexes is for a particular group of semantic types and a single object document may be cataloged in more than one such index.

The concept mapping processes index the object documents according to the rules specified in the terminology index 120. The terminology index 120 is a taxonomy that relates a large number of concepts (e.g., words, phrases, etc.) with synonyms for those concepts. For example, health-related terms may be cross-referenced against multiple synonyms for those terms so as to allow the concept mapping process to properly index individual object documents according to their content. For certain types of resources, such as symptoms for a subject concept of semantic type Diseases/Conditions, the terminology index 120 itself may become a source of content.

The taxonomy that makes up the terminology index may be created by associating one or more attributes to each node in the taxonomy (e.g., each subject concept). For a health-related taxonomy, the attributes may include related diseases, treatments, diagnostic equipment and/or procedures, etc.). Each attribute may be defined linguistically to identify synonyms.

In operation, when a subject document is supplied to the application engine, the application engine examines the document according to the business rules provided by the operator to identify a subject concept in the subject document. When the subject concept is located (e.g., by comparison to terms in the terminology index), its semantic type is determined (again, by reference to the terminology index). Note that because the terminology index is a semantic taxonomy, the subject concept in the document need not be an identical match to the term in the terminology index. The taxonomy itself provides the degree of relationship between the subject concept and the indexed terms.

Based on the identified semantic type and a concept unique identifier (e.g., a number index assigned to each semantic concept to relate the licensed content indexes to the concepts), a search query is formed and targeted towards the corresponding licensed content indexes or other digital asset. The related object document is identified and the application engine creates a hyperlink to that object document and insets it into the subject document at the position of the subject concept. Note that the object resource to which the hyperlink points need not be associated with the portal that provides the subject document. Ay digital asset may be used as an object resource.

The business rule used to configure the above-described processes are quite flexible. For example, the use of such business rules allows an administrator to facilitate the introduction of “sponsored links”. That is, relationships can be defined so that designated subject concepts will be linked to designated content, such as particular drugs, diagnostic equipment, articles, etc.

Thus, the terminology index can be regarded as a taxonomy that prescribes a semantic relations ship between words or phrases and the subject concepts of interest. Diabetes, for example, can be understood as a disease. Fever can be understood as a symptom or a disease. Glucose monitor can be understood as a diagnostic instrument, and so on. This relational affiliation provided by the terminology index allows the application engine to examine subject documents in a meaningful fashion in order to insert links to object resources of great relevance.

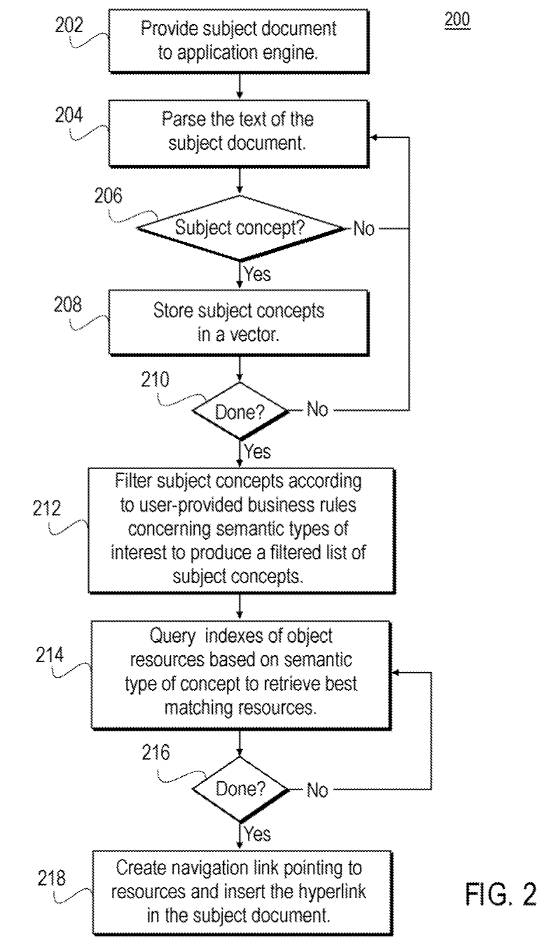

FIG. 2 illustrates an example of a process 200 for processing a batch of subject documents in accordance with an embodiment of the present invention. At step 202 a subject document is provided to the application engine. The text of the document is parsed (204) to identify subject concepts (206), which are stored in a vector. The subject concepts may be identified with reference to the terminology index.

When the entire document has been processed in this fashion (210), the resulting subject concept vector(s) is/are filtered according to user-provided business rules concerning semantic types of interest for the subject document(s), to produce a filtered list of subject concepts (212). When the filtered list has been compiled, the indexes of object resources are queried, based on the semantic type of the subject concept, to retrieve the best matching resources (i.e., the best matching object resources) (214). Once all of the subject concepts for the document have been processed in this fashion (216), the associated hyperlinks to the object resources are created and embedded into the subject document as the locations of the respective subject concepts (218).

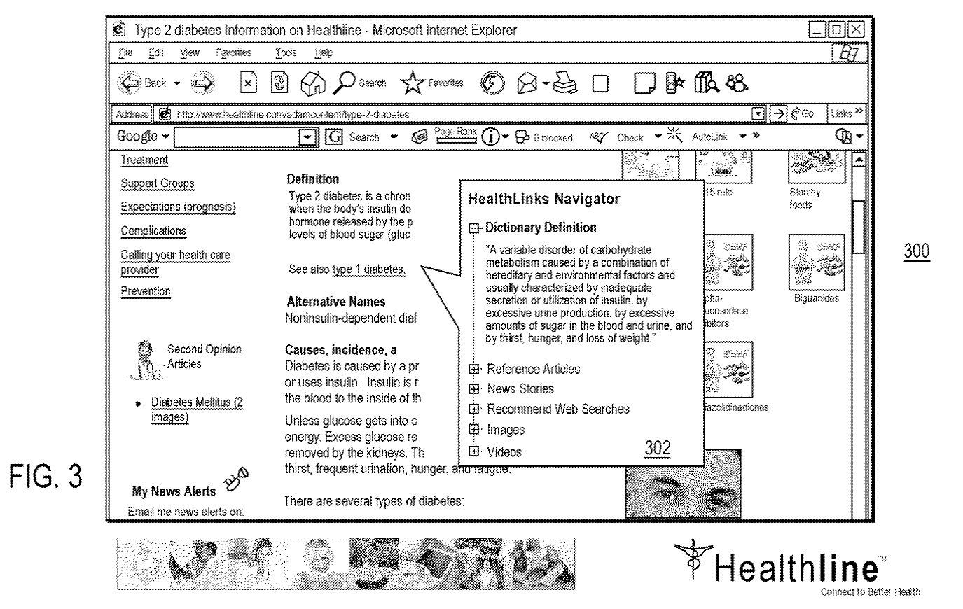

The application engine is capable of linking multiple resources from multiple indexes to a particular subject concept. These links can be rendered in the form of a visual navigator as shown by the example presented in FIG. 3. FIG. 3 is a screen shot 300 showing navigator window 302 that includes hyperlinks to the various object resources linked to a particular subject concept in the subject document displayed in the web browser window. The navigator window 302 may be a pop-up window that is presented in response to a cursor control event, such as a hover over an embedded hyperlink. By presenting the various object resources in this fashion, the user is allowed to choose the one s/he is interested in navigating to. Here, the subject concept “type 1 diabetes” is shown linking to a dictionary definition, reference articles, news stories, recommended web searches, images and video resources, but these are only meant to serve as examples of the kinds of object resources that can be linked to.

The navigator interface is not limited to providing links to concepts defined by the above-described taxonomy. Indeed, links to any object resource can be included, whether as part of a taxonomic group or not. Thus, links videos, images, tools, etc., may be provided, in some cases along with links to disease symptoms, risk factors, etc.

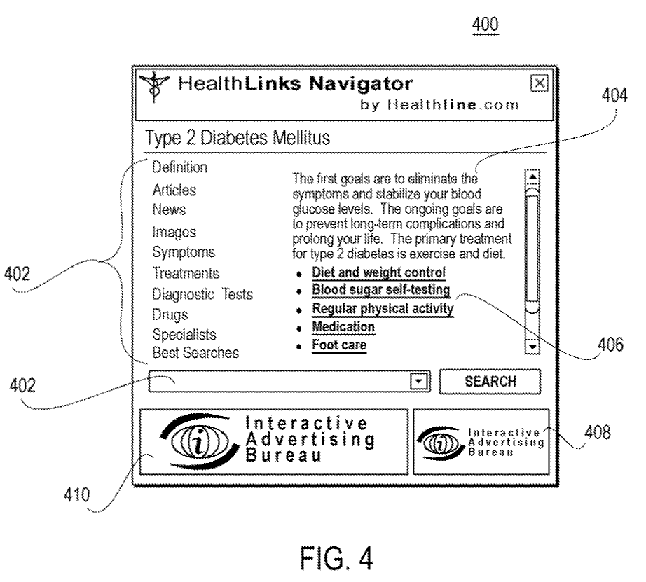

FIG. 4 illustrates a further embodiment of a navigator interface 400. In this example for Type 2 Diabetes, the navigator interface 400 provides ready access to a vast number of object resources, grouped according to a number of categories 402. The categories 402 include: definitions, articles, news, images, symptoms, treatments, diagnostic test, drugs, specialists, and best searches. The present illustration shows an example of the kind of content accessible through the “treatments” category. In this case, certain content 404 has been determined to provide the appropriate high level information suitable for an initial screen and that content (taken from an object resource that was appropriately categorized as discussed above) is displayed to the viewer. At the same time, the viewer is presented with links to a number of content subcategories 406, which are likewise associated with object resources appropriate to the semantic concepts described by the links.

This particular navigator interface 400 also shows how advertisements 408, 410 appropriate to the semantic concepts associated with the content displayed in the interface can be integrated in the display. These advertisements are themselves examples of object resources and are not limited to images. They can be audio/video presentations, flash presentations or other forms of moving images and, in some cases, may themselves be hyperlinked to other content and/or web sites associated with or sponsored by the advertiser. Further, the navigator interface 400 may include a text box 412 to allow a user to enter a search query. Such a search may be used to retrieve specific object resources that provide a best match (or other vector) to the user's query.

Certain optimizations are, of course, possible within the context of the present invention. For example, the rules by which the application engine is engine is configured may be optimized to specify which words in a subject document are linked, as opposed to just allowing for general linking according to any subject concepts found in the subject document (or only restricting such linking based on the semantic type, etc.). Alternatively, or in addition, the collection of which object resources are linked to may be optimized, for example by specifying how the linking is to be done (e.g., in a raked order or other cascading fashion). In one instance, particular semantic types may always be linked to object resources of a certain type or from a certain content provider. Or, the links may be presented in a ranked order defined by user-specified rules, for example, to permit sponsored links or content to be placed in a prominent position within the navigator interface described above. In still other cases, the optimization may involve linking to object resources is a prescribed fashion, for example, first to content from a designated first library, then to content from a designated second library, and finally to any other content from any other libraries that produces a best match or the best number of page views, yields, etc.

Thus, systems and methods for automatically identifying subject concepts within documents and, subject to user-defined rules, associating such concepts with hyperlinks to one or more resources according to semantic relationships between the subject concepts and the resources as defined by a taxonomy have been described. Although the present invention has been discussed with respect to these illustrated examples, the reader is reminded that the invention should not be limited thereby. For example, the present systems and methods allow for any health concept in a document to be identified and linked to its set of attributes. Thus, the present invention is applicable to more than just the identification of diseases, for example. Thus, the invention should be measured only in terms of the claims, which follow.

What is claimed is:

1. A computer-assisted method, comprising automatically identifying a subject concept within a subject document; and, subject to user-defined rules, associating the subject concept with one or more object resources according to semantic relationships between the subject concepts and the object resources as defined by a taxonomy; and inserting one or more hyperlinks to the associated object resources into the subject document.

2. The method of claim 1, further comprising displaying the hyperlinks within a published version of the subject document in response to a cursor-control event.

3. The method of claim 1, wherein the subject concept is a heath-related concept.

4. The method of claim 1, wherein at least one of the object resources is an advertisement.

5. The method of claim 4, wherein the advertisement is related to a heath-related concept that comprises the subject concept within the subject document.

6. The method of claim 1, wherein the object resources comprise digital content.

7. The method of claim 6, wherein the digital content comprises one or more of a document, a spreadsheet, a presentations, a web page, an images, a movie, and an audio file.

8. The method of claim 6, wherein the digital content comprises an encyclopedia article.

9. The method of claim 6, wherein the digital content comprises a collection of documents

10. The method of claim 6, wherein the digital content comprises a quiz.

11. A computer-assisted method, comprising: creating one or more content indexes, each content index including one or more object resources and the content indexes being segregated from one another according to semantic relationships between subject concepts described in the object resources of each content index as defined by a taxonomy; parsing a subject document and identifying at least one of the subject concepts therein; and
associating a hypertext markup language (HTML) version of the subject document with one or more of the object resources that include the subject concepts by inserting one or more hyperlinks to the associated object resources into the HTML version of the subject document at locations of the identified subject concepts.

12. The method of claim 1, further comprising displaying the associations of the HTML version of the subject document to the one or more of the object resources in response to a cursor event.
